(19) United States
(12) Patent Application Publication
(10) Pub. No.: US 2006/0201513 A1
(43) Pub. Date: Sep. 14, 2006

(54) Flat-foldable face-mask and process of making same

(76) Inventor: Wa Chu, Singapore (SG)

Correspondence Address: BROOKS KUSHMAN P.C., 1000 TOWN CENTER, TWENTY-SECOND FLOOR, SOUTHFIELD, MI, 48075, US

(21) Appl. No.: 10/553,133

(22) PCT Filed: Apr. 16, 2004
(86) PCT No.: PCT/SG04/00096

§ 371 Date: Oct. 14, 2005

(30) Foreign Application Priority Data
Apr. 17, 2003 (SG) 200302197-9

(51) Int. Cl. A62B 23/02; A62B 18/02

(52) U.S. Cl. 128/206.19; 128/206.21; 128/206.27; 128/206.28; 128/206.12; 128/206.13; 128/205.25; 128/205.27; 128/205.29

(57) ABSTRACT

Flat-folded personal respiratory device or a face-mask with a first portion and a second portion (31), connecting with each other along at least one common edge, flat-foldable along the common edge(s), a securing mean (32) responsive to the breathing cycle thereby forming an effective respiratory seal as the wearer inhale and release the respiratory seal as the wearer exhale, and a filtering mean (40) to filter inhaling air. A preferred embodiment includes the securing mean includes an elastic headband providing holding force (F) at a location substantially away from the periphery of the face-mask.

### BACKGROUND OF THE INVENTION

This invention relates generally to the field of personal respiratory device or face-mask and more specifically to flat-folded face-mask and process for making same.

Personal respiratory protection devices, also known as filtration respirators or face-masks, are used in a wide variety of applications to protect a wearer's respiratory system from particles suspended in the air or from unpleasant or noxious gases. Face-masks are typically designed to be worn over the nose and the mouth to protect the wearer from undesirable material suspended in the air. Generally, these types of face-masks come in two basic designs—a molded cup-shaped form or a flat-folded form.

It has been found that flat-folded face-masks can conform quite closely to the wearer's face, that is most of the inner surface of the mask may come into contact with the face and the cheeks of the wearer. Thus, flat face-mask may be warm and uncomfortable during use, and is particularly true when the face-mask is worn for extended periods of time. In addition the inner surface of the mask may come into contact with the wearer's mouth such that the face-mask often becomes wet and abraded. When this happens, the abraded material from the inner surface may irritate the wearer.

Face-mask of conventional flat-folded form is typically constructed by incorporating a fabric that is rectangular in parallel to the mouth of the wearer. Such constructions may have a stiffening element to hold the face-mask away from contact with the wearer's face. Stiffening has also been provided by fusing a pleat across the width of the face-mask in a laminated structure or by providing a seam across the width of the face-mask. In many applications, it is particularly desirable to provide such a face-mask having a generally flat configuration for easy storage prior to donning the face-mask. The flat-folded form has advantages in that it can be easily stored, such as in a wearer's pocket.

Cup-shaped face-mask are typically molded masks that form an air-chamber over the face when in use thereby overcoming some of the comfort concerns related to flat folded masks. However, molded cup-shaped masks may not be folded flat for easy and convenient storage.

U.S. Pat. No 3,971,369 to Aspelin et al. discloses a generally cup shaped surgical mask that is not molded. The patent discloses that because the mask is not molded, the edges of the body portion of the mask are not rigid and therefore conform to the contours of the wearer's face. However, the mask is complicated to manufacture and the resulting design is pleated, having overlapping material on the front of the mask.

U.S. Pat. No. 6,536,434 B1 to Bostock et al. discloses a flat-folded personal respiratory device. In that publication, it is described that the devices include a flat central portion, a flat first member joined to the central portion through either a fold-line, seam, weld, or bond and a second member joins capable of being folded flat for storage with the first and second members being in at least partial face to face contact with a common surface of the central portion and, during use, is capable of forming a cup-shaped air chamber over the nose and the mouth of the wearer.

According to World Health Organization publication (1999, Health Guidelines for Vegetation Fire Events, Lima, Peru, 6-9 Oct. 1998), good protection can be achieved only if a goespiratory seal exist between a face-mask and the face of the wearer.

In order to achieve sufficient respiratory seal, unlike molded cup shaped face-masks, the prior disclosures of flat folded face-masks cover a large area substantially beyond the essential nose and the mouth of the wearer. To improve the respiratory seal the wearer must secure the face-mask tightly against the face by a strap or elastic headband encircles the wearer's head or by a pair of ear-loop. While improving respiratory seal, the wearing may become uncomfortable because of heat built up under the mask and the stress produced by the strap, the elastic band or the ear-loop, especially after extended period of use.

Another source of air leakage comes from the area around the nose. Many flat folded face-masks come with a user adjustable nose clip to reduce the air leakage around the nose profile. However, not every user is skillful to make a proper adjustment of the nose clip such that it fit snugly in order to affect a respiratory seal. Further, this additional element increases complexity and cost of manufacturing.

Commercially available disposable face-masks typically provided with integrated strap, elastic headband or ear-loops. The integrated strap, elastic headband or ear-loops has to be through away together with the face-mask after use. This is not good neither for economic nor environmental concern.

### BRIEF SUMMARY OF THE INVENTION

The primary object of the invention is to provide a flat-foldable face-mask that is easy to carry and store.

Another object of the invention is to provide a face-mask that is comfortable to wear.

Another object of the invention is to provide a face-mask that covers essential nose and mouth area of a wearer.

A further object of the invention is to provide effective respiratory seal during the breathing cycle.

Yet another object of the invention is to provide a face-mask that is adaptive and fit snugly to a wearer's nose profile without the need of a nose clip or similar attachments.

Still yet another object of the invention is to provide a face-mask that is adaptive to a wide range of face size.

Another object of the invention is to provide a face-mask made from flat sheet material.

Another object of the invention is to provide a face-mask that is easy and low cost to make.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed flat-folded personal respiratory device or a face-mask comprising: a first portion connecting to a second portion along a common edge and flat-foldable along the common edge, securing mean to secure said face-mask onto the face of a wearer and is capable of forming an effective respiratory seal as said wearer inhale, and release the respiratory seal as said wearer exhale, and filtering mean to filter unwanted particles from inhaling air.

In accordance with a preferred embodiment of the invention, there is disclosed a process for making flat-folded personal respiratory device or a face-mask as claimed in A1 comprising: a first step of folding a roll of sheet material along the length of the sheet material, a second step of welding the folded sheet material along pre-defined weld-lines, and a third step of cutting pre-defined shape of a face-mask in the flat-folded configuration out of the roll of folded and welded sheet material.

### BRIEF DESCRIPTION OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front view of a face-mask of the present invention.

FIG. 2 is a perspective view of a face-mask of the present invention.

FIG. 3 is a side view of a face-mask of the present invention.

FIG. 4 shows the critical areas forming a respiratory seal of the present invention.

FIG. 5 is a cross section view along the direction (AA) in FIG. 1.

FIG. 6 shows a face-mask of the present invention is capable of adapting to a large and a small faces size.

FIG. 7 is a perspective view comparing the difference in area of coverage between a typical flat-folded face-mask and a face-mask of the present invention.

FIG. 8a shows a side view of a face-mask of the present invention in flat-folded configuration.

FIG. 8b shows a front view of a face-mask of the invention in open convex configuration.

FIGS. 9a˜9d show the side views of face-masks of the present invention in flat-folded configuration.

FIG. 10 shows a schematic flat development of a face-mask of the invention.

FIG. 11 shows a detail to secure an elastic band for a face-mask of the invention.

FIG. 12a showing a side view of a face-mask of the invention with a stiffener

FIG. 12b shows a front view of a face-mask of the invention with a stiffener

FIG. 13a shows a side view of a face-mask of the invention with integrated filter and stiffener.

FIG. 13b shows a front view of a face-mask of the invention with integrated filter and stiffener.

FIG. 14a shows a side view of a face-mask of the invention with user changeable filter-inserts.

FIG. 14b shows a front view of a face-mask of the invention with user changeable filter-inserts.

FIG. 14c shows a cross sectional view (BB) of the details of a user changeable filter construction.

FIG. 15 shows a schematic view of a process for making a face-mask.

FIG. 16 shows a picture of a prototype face-mask on a wearer with a large face dimension.

FIG. 17 shows a picture of a prototype face-mask on a wearer with a small face dimension.

FIG. 18 shows a super-impost picture of a prototype face-mask during a breath cycle.

### DETAIL DESCRIPTION OF THE PREFERRED EMBODIMENTS

Detailed descriptions of the preferred embodiment are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure or manner.

For the purpose of this invention, the following terms shall have the meaning as defined:

‘Convex open configuration’ shall mean a configuration of the device in use wherein the main body is substantially off the face of the wearer, yet is in sealing engagement with the face to provide an air chamber over the nose (33) and mouth (34), (35) of the wearer.

‘Weld-line’ shall mean a common edge shared by two or more parts and connected by means of embossing, adhesive bonding, ultrasonic welding, heat-welding, sewing or other means commonly known to those skilled in the art.

### PREFERRED EMBODIMENTS

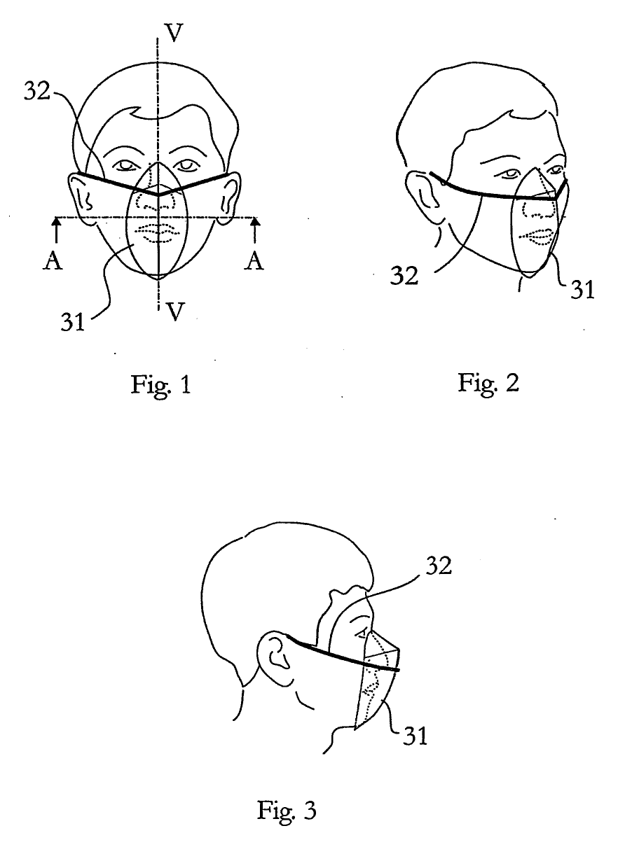

In a preferred embodiment of the present invention, a main body (31) of a flat-foldable personal respiratory device or a face-mask is capable of unfolding into a convex open configuration. FIGS. 1, 2 & 3 are respectively the front, perspective and side view of said face-mask. Looking from the side, FIG. 3 shows there is sufficient room of clearance for the wearer's nose and mouth.

The main body (31) preferably made of filter media capable of filtering unwanted particles suspended in the air, to protect the wearer from environment irritation.

FIG. 12a shows a stiffener (39) may be inserted or welded in position to form an integrated part of the main body (31f)

As shown in FIG. 13a, in a second preferred embodiment of the present invention, a main body (31n) is preferably made of non-filter material; a filter part (40) made of filtering material is welded and forming an integrated part of the main body (31n). Preferably the filter part (40) is capable of functioning as a stiffener, or alternatively, a stiffener layer can be welded together with the filter part onto the main body (31n).

Shown in FIGS. 14a, 14b & 14c is a third preferred embodiment of the present invention. A main body (31n) is preferably made of non-filter material; at least one filter holder (41) is glued or welded and forms an integrated part of the main body. A user replaceable filter material (43) can be secured in place by a releasable filter guard (42).

Filter Material

In all prefer embodiments of the present invention, the filter material may be comprised of a number of woven and nonwoven materials, a single or a plurality of layers, with or without an inner or outer cover layer.

As taught by U.S. Pat. No. 6,394,090 B1, examples of suitable filter material include microfiber webs, fibrillated film webs, woven or nonwoven webs (e.g., airlaid or carded staple fibers), solution-blown fiber webs, or combinations thereof. Fibers useful for forming such webs include, for example, polyolefins such as polypropylene, polyethylene, polybutylene, poly (4-methyl-1-pentene) and blends thereof, halogen substituted polyolefins such as those containing one or more chloroethylene units, or tetrafluoroethylene units, and which may also contain acrylonitrile units, polyesters, polycarbonates, polyurethanes, rosin-wool, glass, cellulose or combinations thereof.

Fibers of the filtering layer are selected depending upon the type of particulate to be filtered. Proper selection of fibers can also affect the comfort of the respiratory device to the wearer, e.g., by providing softness or moisture control. Webs of melt blown microfibers useful in the present invention can be prepared as described, for example, in Wente, Van A., ‘Superfine Thermoplastic Fibers’ in Industrial Engineering Chemistry, Vol. 48, 1342 et seq. (1956) and in Report No. 4364 of the Naval Research Laboratories, published May 25, 1954, entitled ‘Manufacture of Super Fine Organic Fibers’ by Van A. Wente et al. The blown microfibers in the filter media useful on the present invention preferably have an effective fiber diameter of from 3 to 30 mlcrometers, more preferably from about 7 to 15 micrometers, as calculated according to the method set forth in Davies, C. N., ‘The Separation of Airborne Dust Particles,’ Institution of Mechanical Engineers, London, Proceedings 1B, 1952.

Staple fibers may also, optionally, be present in the filtering layer. The presence of crimped, bulking staple fibers provides for a more lofty, less dense web than a web consisting solely of blown microfibers. Preferably, no more than 90 weight percent staple fibers, more preferably no more than 70 weight percent are present in the media. Such webs containing staple fiber are disclosed in U.S. Pat. No. 4,118,531 (Hauser).

Bicomponent staple fibers may also be used in the filtering layer or in one or more other layers of the filter media. The bicomponent staple fibers which generally have an outer layer which has a lower melting point than the core portion can be used to form a resilient shaping layer bonded together at fiber intersection points, e.g., by heating the layer so that the outer layer of the bicomponent fibers flows into contact with adjacent fibers that are either bicomponent or other staple fibers. The shaping layer can also be prepared with binder fibers of a heat-flowable polyester included together with staple fibers and upon heating of the shaping layer the binder fibers melt and flow to a fiber intersection point where they surround the fiber intersection point. Upon cooling, bonds develop at the intersection points of the fibers and hold the fiber mass in the desired shape. Also, binder materials such as acrylic latex or powdered heat activatable adhesive resins can be applied to the webs to provide bonding of the fibers.

Electrically charged fibers, such those disclosed in U.S. Pat. No. 4,215,682 (Kubik et al.), U.S. Pat. No. 4,588,537 (Klasse et al.), or by other conventional methods of polarizing or charging electrets, e.g., by the process of U.S. Pat. No. 4,375,718 (Wadsworth et al.), or U.S. Pat. No. 4,592,815 (Nakao), or by a hydrocharging method described in U.S. Pat. No. 5,496,507 (Angadjivand et al.) are particularly useful in the present invention. Electrically charged fibrillated-film fibers as taught in U.S. Pat. No. RE. 31,285 (van Turnhout), are also useful.

Sorbent particulate material (such as activated carbon or alumina) and/or sorbent fibers (e.g., activated carbon fibers) may also be included in the filtering layer. Such particle-loaded webs are described, for example, in U.S. Pat. No. 3,971,373 (Braun), U.S. Pat. No. 4,100,324 (Anderson) and U.S. Pat. No. 4,429,001 (Kolpin et al.). Masks from particle loaded filter layers are particularly good for protection from gaseous materials. As mentioned above, a respiratory device for filtering airborne particulates of the present invention must include a filter layer in at least the one portion. Preferably, the entire respiratory device in accordance with the present invention includes a filter layer.

Respiratory Seal

An important aspect of the present invention includes securing means to secure a face-mask onto the face of a wearer forming an effective respiratory seal as said wearer inhales, and releases the respiratory seal as said wearer exhales. The working principle will be explained in detail in a non-limiting example set forth below.

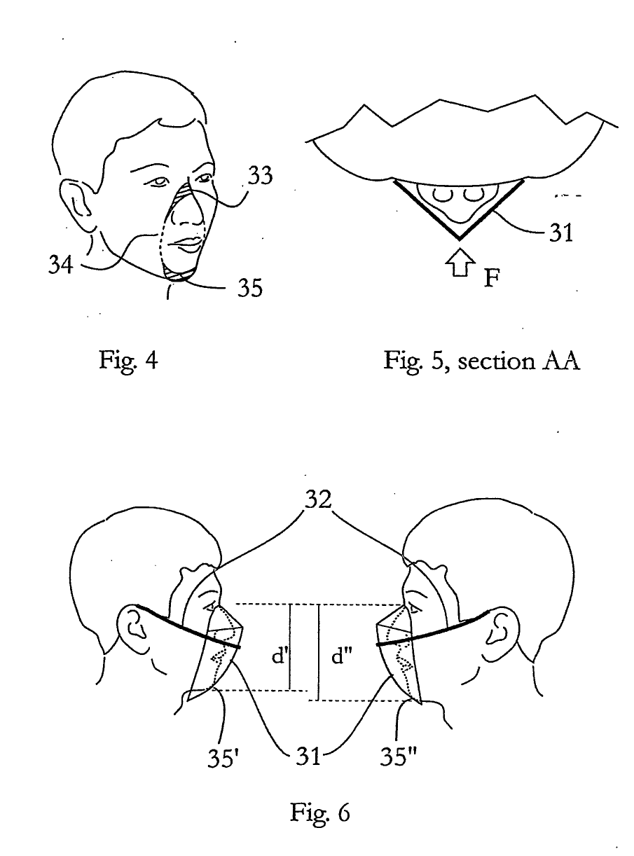

Reference to FIG. 4 and FIG. 5, according to the present invention, a face-mask (31) is preferably secured by an elastic headband (32) attached to the face-mask substantially away from the periphery; the resultant force (F) provides a positive pressure holding the face-mask (32) against the face of a wearer. The resultant force (F) is regionalized and provides a positive pressure and respiratory seal in the area of (33). The regionalized sealing effect is further enhanced by two factors due to the substantially triangulated shape of the main body of the face-mask near the nose of the wearer. Along the direction of the force (F) the triangulated shape of the main body provides a relative rigid structure, preferably enhanced by integrated stiffener (39 or 40), therefore it is able to transmit substantial portion of the force (F) to the face of the wearer with little losses and forming a consistent seal especially around the lower portion of (33). Along the surface of the face-mask, the area (33) covering the nose of the wearer, in a direction approximately perpendicular to the direction of the force (F), the sheet material is relatively flexible and readily complies and fit snugly onto different nose shapes of different wearers. The combine results of rigidity along the direction of (F) and flexibility perpendicular to (F) provides a consistent and effective respiratory seal in the area (33) around the nose of a wearer.

In proper wearing condition, most of the periphery (34) (45) of a face-mask according to the present invention is free to move, although within a small margin.

This is different from the prior arts of flat-folded face-masks (U.S. Pat. No. 6,394,090 B1, U.S. Pat. No. 6,332,465 B1, U.S. Pat. No. 6,536,434 B1, U.S. Pat. No. 6,336,459 B1, U.S. Pat. No. 5,706,803, U.S. Pat. No. 6,474,336 B1, U.S. Pat. No. 3,971,369) whereas a headband or ear-loops is attached substantially near to the periphery of the face-mask and therefore restricting the movement of the periphery.

When the wearer inhale the air pressure within the air chamber formed by the face-mask drops and the external atmospheric pressure pushes the surfaces and periphery (34) (45) of the face-mask inward (FIG. 18), enhancing the respiratory seal and forcing the inhaling air to go through the filter material part(s) of the face-mask, therefore ensuring the protection of the respiratory system of the wearer.

Alternatively when the wearer exhale the air pressure within the air chamber raises and becomes higher then the external atmospheric pressure, the surfaces and periphery (34) (45) of the face-mask is therefore pushed outward and subsequently the respiratory seal can be released to facilitate advantageously quick release of exhaled air.

Face Sizes

In accordance with the present invention, a flat foldable face-mask is capable of engaging a respiratory seal with a wide range of face sizes. FIG. 6 illustrated a face-mask of the present invention adapting to two different face sizes, defined by the eye-to-chin dimension (d′) and (d′). While wearing on the shorter face (eye-to-chin dimension=d′), the engagement area of the chin (35′) is higher then the corresponding engagement area of the chin (35′) of a longer face (eye-to-chin dimension=d′). Any face with the eye-to-chin dimension lying between d′ and d′ will find an engagement area of the chin fall within the space between 35′ and 35′.

Experiments with a prototype show that a fit size face-mask in accordance with the present invention is able to adapt to engaging a respiratory seal with the following face sizes:

Short face (eye-to-chin dimension) d′=94 mm

Long face (eye-to-chin dimension) d′=114 mm

The experiments involve the following steps:

1) The wearer put on the face-mask.)

2) The wearer adjusts the face-mask so that it fits snugly and comfortably against the nose and the mouth.)

3) The wearer tries to exhale to check if the exhaling breath can be released easily. (If easy to exhale=pass)

4) Wearer try to inhale to sense if there is negative pressure built up within the air chamber and visually check if there are signs of the surface collapse (FIG. 18) on the main body and the periphery. (Sensation of negative pressure+signs of surface collapse=pass)

Further investigation into the U.S. human factor data of eye-to-chin dimension (MIT Press, Humanscale copyright 1991 by Henry Dreyfuss Associates: head height head to eye dimension), it is shown that the range of 94 mm to 114 mm is sufficient to cover at least 99 percent of U.S. female population and 97.5 percent of U.S. male population as illustrated in the table here:

| Woman | | Man | |
|---|---|---|---|
| Percentile | eye-to-chin | Percentile | eye-to-chin |
| 1 | 94 | 1 | 101 |
| 2.5 | 96 | 2.5 | 104 |
| 5 | 97 | 5 | 104 |
| 25 | 101 | 25 | 109 |
| 50 | 104 | 50 | 109 |
| 75 | 105 | 75 | 112 |
| 95 | 104 | 95 | 114 |
| 97.5 | 107 | 97.5 | 114 |
| 99 | 104 | 99 | 116 |

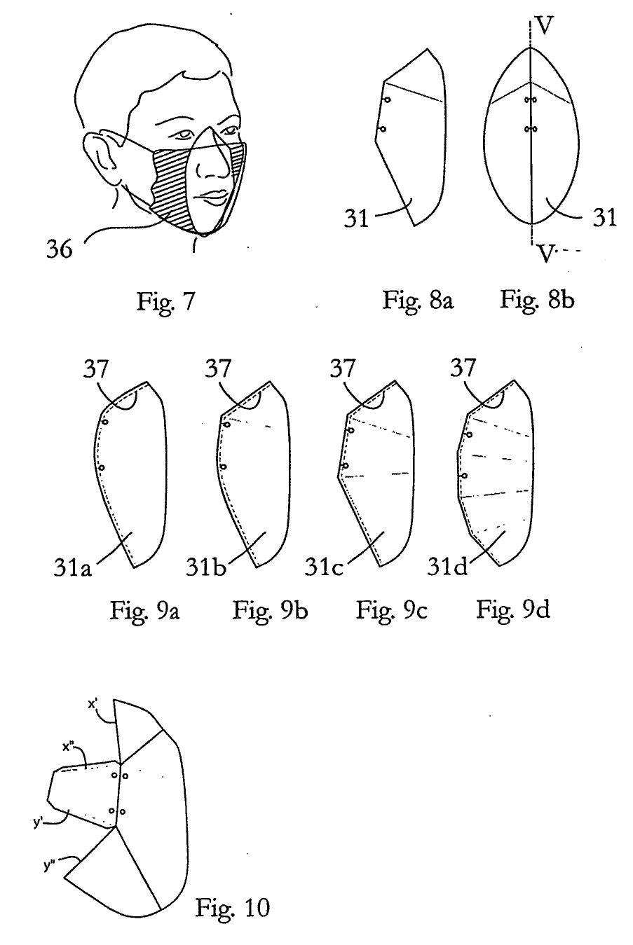

In accordance with the present invention, a flat-folded face-mask covers substantially less area then prior arts of flat-folded face-masks (U.S. Pat. No. 6,394,090 B1, U.S. Pat. No. 6,332,465 B1, U.S. Pat. No. 6,536,434 B1, U.S. Pat. No. 6,336,459 B1, U.S. Pat. Nos. 5,706,803, 6,474,336 B1, U.S. Pat. Nos. 3,971,369, 6,308,330 B1). FIG. 7 illustrates a typical reduced area of coverage (36) of the present invention compare to a typical flat-folded face-mask. The reduction in covering area improves ventilation and promotes better cooling and comfort for the wearer especially in countries of warm climate.

Shapes

Face mask of the present invention are further described by way of non-limiting examples set forth below. In each of the examples, two substantially similar parts are connected along a common edge(s) to form the flat-folded main body of a face-mask and is convertible to open-convex-configuration.

FIG. 9a shows a face-mask according to the present invention with one curve weld-line.

FIG. 9b shows a face-mask according to the present invention with one straight weld-line and one curve weld-line.

FIG. 9c shows a face-mask according to the present invention with 3 straight weld-lines.

FIG. 9d shows a face-mask according to the present invention with 5 straight weld-lines.

Alternatively a face-mask according to the present invention can also be fabricated by folding a specially shaped sheet material.

FIG. 10 shows a special shaped sheet material that can be folded up by connecting edge x′ to edge x′ and edge y′ to edge y′. The resulting shape is substantially similar to FIG. 9c.

Attachment Constituents

A device in accordance with the present invention preferably also includes attachment constituents, such as a headband (32) or an ear loop (not shown). More preferably the attachment constituent is user-replaceable and reusable.

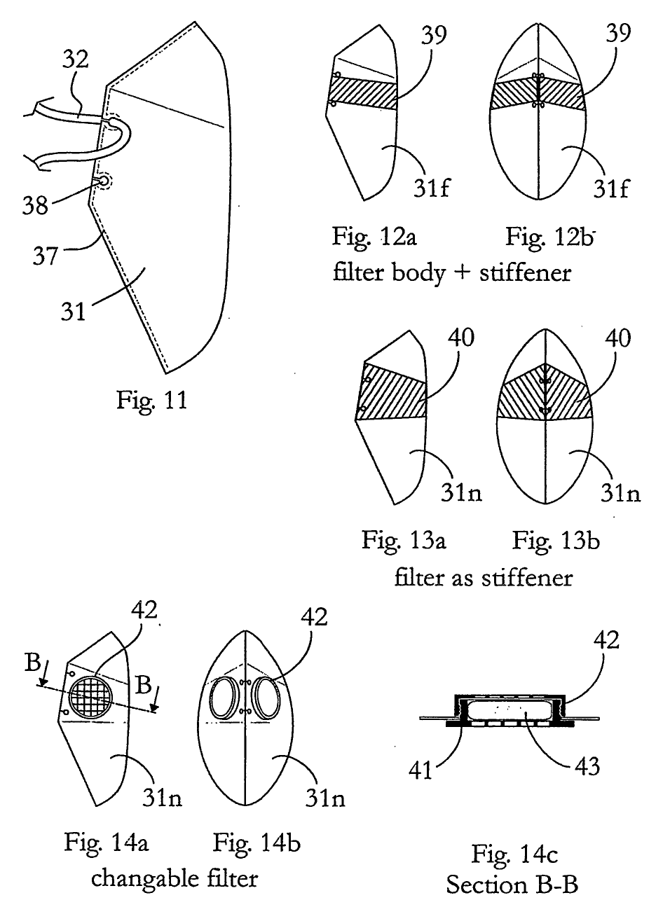

FIG. 11 illustrates a non-limiting example of a user-replaceable and reusable method of attachment constituent of an elastic headband (32). The elastic headband is releasably secured onto a face-mask through a slot (38) along a weld-line (37). More then one slots (38) may be introduced along the edge of the weld-line to provide different securing points for the comfort of different users.

As disclosed by U.S. Pat. No. 6,394,090 B1, elastic straps or bands useful in the present invention may be constructed from thermoplastic elastomers, resilient polyurethane, polyisoprene, butylene-styrene copolymers. One such example is a styrene-butadiene-styrene block copolymer, commercially available under the trade designation KRATON D 1101, from Shell Chemical Co., Houston, Tex. Straps or bands may also be constructed from elastic rubber or a covered stretch yarn, such as that commercially available under the trade designation LYCRA, from DuPont Co., Wilmington, Del. Also useful for straps or bands in the present invention are stretch activated, elastomeric composite materials. One such material is a non-tacky, multilayer elastomeric laminate having at least one elastomeric core and at least one relatively nonelastomeric skin layer. The skin layer is stretched beyond its elastic limit and is relaxed with the core so as to form a microstructured skin layer. Microstructure means that the surface contains peak and valley irregularities or folds which are large enough to be perceived by the unaided human eye as causing increased opacity over the opacity of the composite before microstructuring, and which irregularities are small enough to be perceived as smooth or soft to human skin. Magnification of the irregularities is required to see the details of the microstructured texture. Examples of such elastomeric composites are disclosed in U.S. Pat. No. 5,501,679 (Krueger).

Although elastic bands are preferable, non-elastic bands may also be used in the present invention and include, for example, non-woven materials formed by both wetlaid or dry-laid processes and consisting of rayon, polyester or like fibers, calendared spun-bonded webs of polypropylene, polyethylene or polyester and reinforced paper. The bands can be tied, clasped, or stretched such that the bands encircle the head of the wearer bringing the face mask in sealing engagement with the face of the wearer.

Production Process

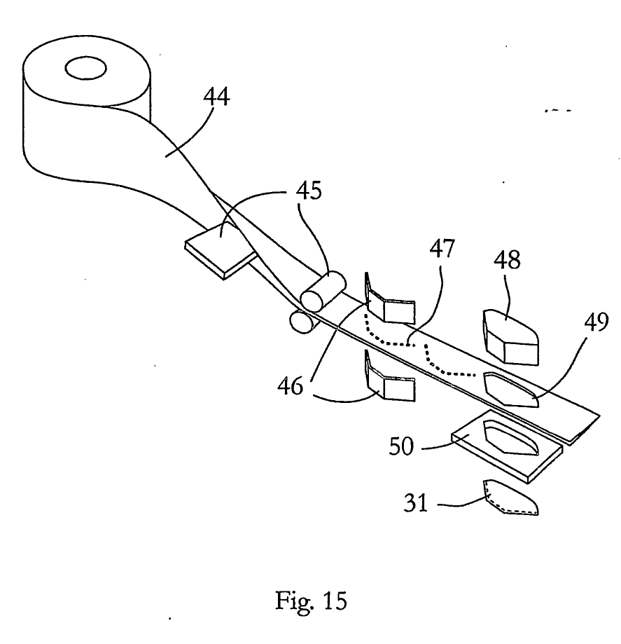

A preferred process of making a face-mask of the present invention is illustrated schematically in FIG. 15. The preferred process comprises at least three essential steps, first is folding, second is welding and third is cutting. Filter media in the form of sheet roll is transported towards a folding device (45) to fold the sheet roll in half along the length of the sheet roll material. The folded sheet roll is then fed towards the welding area, subsequently the two face-to-face layers of the folded sheet roll is welded by the welding devices at predetermined interval. The welded roll sheet continue to be fed to a cutting devices, (48, 50), there the face-masks (31) will be cut out of the sheet material by the cutting devices (48, 50).

Face-mask of the present invention can be sterilized by any standard method, such as gamma radiation, exposure to ethylene oxide, or autoclaving.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Flat-folded personal respiratory device or faces mask comprising:
a first portion and a second portion, connecting with each other along at least one common edge, flat-foldable along the common edge(s);
securing mean to secure said face-mask on the face of a wearer thereby forming an effective respiratory seal as the wearer inhale and release the respiratory seal as the wearer exhale; and
filtering mean to filter inhaling air.

2. Flat-folded breathing-mask as claimed in claim 1 wherein said effective respiratory seal covers a minimum yet essential area of nose (33), chin (35) and two symmetrical edges (34) connecting (33) and (35).

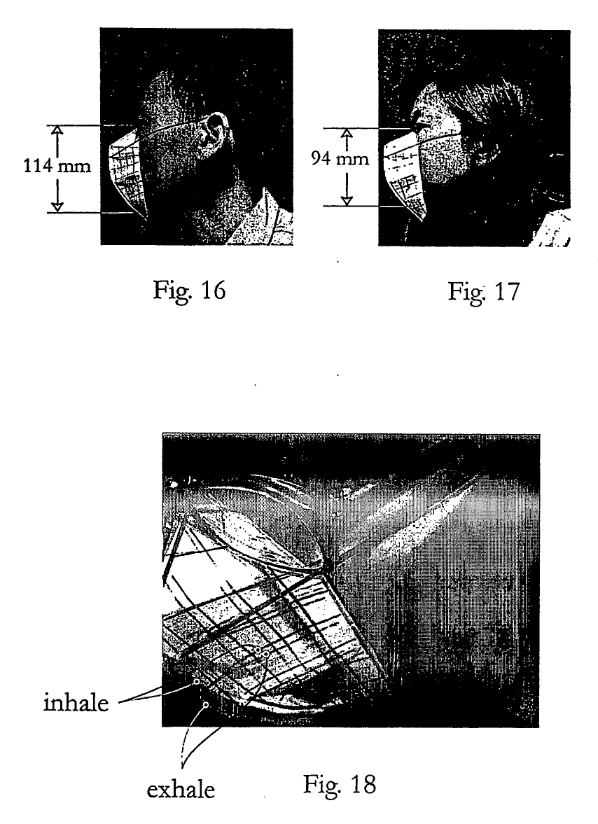

3. Flat-folded breathing-mask as claimed in claim 2 wherein said essential area is adaptive to an extensive range of face sizes which is defined by eye-to-chin distance at least range from 94 mm to 104 mm as shown in FIG. 16 and FIG. 17.

4. Flat-folded breathing-mask as claimed in claim 1 wherein said securing mean includes an elastic headband providing holding force (F) at location substantially away from the periphery of the face-mask.

5. Flat-folded breathing-mask as claimed in claim 1 wherein said filtering mean includes the main body of the breathing-mask made of filtering sheet material

6. Flat-folded breathing-mask as claimed in claim 1 wherein said filtering mean includes a filter part integrated in the main body of the face-mask.

7. Flat-folded breathing-mask as claimed in claim 1 wherein said filtering mean includes a user replaceable filter part.

8. A process for making flat-folded personal respiratory device or a face-mask as claimed in claim 1 comprising:
first step of folding a roll of sheet material along the length of the sheet material;
second step of welding the folded sheet material along pre-defined edge(s); and
third step of cutting the shape of the face-mask in the flat-folded configuration out of the roll of sheet material.

9. A process for making flat-folded personal respiratory device or a face-mask as claimed in claim 6 wherein said roll of sheet material includes as least two layers construction.

10. A process for making flat-folded personal respiratory device or a face-mask as claimed in claim 1 comprising:
first step of folding a flat sheet material;
second step of welding the folded sheet material along pre-defined edge(s); and
third step of cutting the shape of the face-mask in the flat-folded configuration out of the sheet material.

11. A process for making flat-folded personal respiratory device or a face-mask as claimed in claim 8 wherein said sheet material includes as least two layers construction.
